(19) United States
(12) Patent Application Publication
(10) Pub. No.: US 2025/0172678 A1
(43) Pub. Date: May 29, 2025

(54) SYSTEM FOR DETECTING AT LEAST ONE OBJECT IN THE SURROUNDINGS OF A VEHICLE, AND VEHICLE COMPRISING SUCH A SYSTEM

(71) Applicant: Robert Bosch GmbH, Stuttgart (DE)

(72) Inventors: Peyman Rafiee, Esslingen (DE); Thomas Treptow, Leonberg (DE); Mercedes Garcia Conde, Gerlingen (DE)

(21) Appl. No.: 18/715,865

(22) PCT Filed: Nov. 21, 2022
(86) PCT No.: PCT/EP2022/082619

§ 371 Date: Jun. 3, 2024

(30) Foreign Application Priority Data
Dec. 13, 2021 (DE) 10 2021 214 203.6

(51) Int. Cl. G01S 7/539; G01S 15/88

(52) U.S. Cl. CPC G01S 7/539; G01S 15/88

(57) ABSTRACT

A system for detecting at least one object in the surroundings of a vehicle. The system includes at least one ultrasonic sensor unit for transmitting ultrasonic signals and for receiving reflected ultrasonic echo; and a processing unit configured to excite the ultrasonic sensor unit with a first frequency to transmit first ultrasonic signals, and to detect the first ultrasonic signals as first ultrasonic echo signals when reflected on the object and received using the ultrasonic sensor unit, and to excite the ultrasonic sensor unit with a second frequency to transmit second ultrasonic signals, and to detect the second ultrasonic signals as second ultrasonic echo signals when reflected on the object and received using the ultrasonic sensor unit, and, based on the received first ultrasonic echo signals and second ultrasonic echo signals, to detect the object in the surroundings of the vehicle and to determine a height of the object.

### FIELD

The present invention relates to a system for detecting at least one object in the surroundings of a vehicle.

### BACKGROUND INFORMATION

In the field of driving assistance systems and parking assistance systems for vehicles, ultrasonic sensor systems for detecting the vehicle environment are widely used. The problem with conventional ultrasonic sensor systems is that ultrasonic sensors can typically only be used to measure distances. However, these ultrasonic sensors are generally arranged in a horizontal plane on the vehicle, with the result that height determination can only be implemented very imprecisely since data comprising information about the vertical nature of objects can only be ascertained inadequately.

The present invention is intended to solve the stated problems.

### SUMMARY

The present invention relates to a system for detecting at least one object in the surroundings of a vehicle. According to an example embodiment of the present invention, the system includes
at least one ultrasonic sensor unit for transmitting-ultrasonic signals and for receiving reflected ultrasonic echo signals, in particular reflected on the at least one object in the surroundings of the vehicle, and
a processing unit, wherein the processing unit is configured to excite the ultrasonic sensor unit with a first frequency to transmit first ultrasonic signals, and to detect the first ultrasonic signals as first ultrasonic echo signals when reflected on the object and received by means of the ultrasonic sensor unit, and additionally to excite the ultrasonic sensor unit with a second frequency to transmit second ultrasonic signals, and to detect the second ultrasonic signals as second ultrasonic echo signals when reflected on the object and received by means of the ultrasonic sensor unit, and, on the basis of the received first ultrasonic echo signals and second ultrasonic echo signals, to detect the object in the surroundings of the vehicle and to determine a height of the object.

This is advantageous in that the transmitted ultrasonic signals each have different radiation characteristics in the form of different opening angles due to the different excitation frequencies. The higher the frequency, the smaller the opening angle of the transmitted ultrasonic signals. Thus, the size of the conical detection areas defined by the opening angles depends on the excitation frequency of the ultrasonic sensor unit. As a result, additional information can thus be detected by means of a single ultrasonic sensor unit, in particular also in the vertical plane, and can be used to more accurately determine the height of the object. In addition, the ultrasonic sensor unit used as standard for distance determination does not need to be redesigned or only needs to be redesigned insignificantly, with the result that the corresponding costs for a redesign can be eliminated.

Of course, it is also possible that the system comprises additional ultrasonic sensor units, which are arranged horizontally, in particular for the distance determination, in order to further increase the information density and thus the accuracy of the height determination.

An object can be understood to be any object outside the vehicle, including pedestrians, curbs or posts, for example. Here, height is to be understood to mean the extension of the object in the vertical direction, i.e., the distance between the ground and the highest point of the object that is perpendicular thereto.

The vehicle may, for example, be a passenger car, a truck, or also an, in particular motorized, two-wheeler.

Everything outside the actual vehicle geometry, for example the road in front of the vehicle, can be understood as the surroundings of the vehicle.

According to an example embodiment of the present invention, for transmitting the ultrasonic signals or receiving the ultrasonic echo signals, the ultrasonic sensor unit in particular comprises an ultrasonic transceiver, which can convert electrical signals into ultrasonic signals by means of a membrane or can convert ultrasonic echo signals into electrical signals by means of the membrane. The first and second frequencies that excite the membrane are different from one another. The membrane may, for example, be designed as a piezo element or comprise such an element.

According to an example embodiment of the present invention, the processing unit may, for example, be designed as a microcontroller and, as required, comprise corresponding evaluation units and storage units for determining the object height. In particular, the term “determine” is also to be understood to mean “estimate.”

One example embodiment of the present invention provides that the processing unit is configured to select the first frequency and the second frequency such that the first frequency corresponds to a main resonance frequency of the ultrasonic sensor unit and that the second frequency corresponds to a frequency of a higher oscillation mode of the ultrasonic sensor unit, and in particular that the second frequency corresponds to a harmonic resonance frequency of the ultrasonic sensor unit. This is advantageous in that the ultrasonic sensor unit can be controlled particularly reliably at the main resonance frequency and at its higher oscillation modes or harmonic. The corresponding frequencies are adapted to the bending behavior of the membrane of the ultrasonic sensor unit.

The main resonance frequency is to be understood to mean the frequency at which the membrane of the ultrasonic sensor unit exhibits a corresponding bending behavior due to the excitation with this frequency, which is usually also referred to as the fundamental frequency.

The frequency of a higher oscillation mode is to be understood to mean a frequency which is higher than the fundamental frequency and at which the membrane of the ultrasonic sensor unit exhibits a corresponding oscillation behavior, which is also referred to as the natural oscillation mode.

The harmonic frequencies are in turn integer multiples of the main resonance frequency.

For example, the first frequency may be 48 kHz, as the fundamental frequency, and the second frequency may be 144 kHz, as the third harmonic.

It can also happen that, when the ultrasonic sensor unit is excited with the fundamental frequency, the ultrasonic sensor unit additionally oscillates with a corresponding harmonic frequency to the fundamental frequency as a secondary effect. However, the ultrasonic signals have a significantly smaller amplitude in the harmonic range than when the ultrasonic sensor unit is specifically excited with the harmonic frequency. Consequently, the height determination can also be carried out on the basis of the amplitude ratio between the amplitude of the secondary excitation and the amplitude of the specific harmonic excitation. However, the amplitude can also be so small that a reliable height determination is not possible or can only be implemented in the near field range.

One example embodiment of the present invention provides that the processing unit is configured to excite the ultrasonic sensor unit with the first frequency and the second frequency substantially simultaneously.

This is advantageous in that a faster measurement result is achieved than if the measurement is carried out sequentially.

The result of the height determination can thus be obtained and used for other purposes correspondingly more quickly, for example for controlling corresponding driving functions or for informing the driver about the height of the detected object.

The term “substantially simultaneously” is to be understood to mean that both the first and second ultrasonic signals are transmitted such that the transmission of both ultrasonic signals takes place before the first and second ultrasonic echo signals are received. This can be implemented, for example, by the excitation signal for the ultrasonic sensor unit exciting both the first and the second frequency.

Alternatively, a relevant excitation signal for the first and for the second frequency can each be fed to the ultrasonic sensor unit in immediate succession in order to excite the ultrasonic sensor unit accordingly.

A further example embodiment of the present invention provides that the processing unit is configured to determine the height of the object on the basis of amplitudes and/or phases and/or flight times of the first ultrasonic echo signals and second ultrasonic echo signals.

This is advantageous in that this is a simple method to determine the height of the object.

The amplitude of the ultrasonic echo signals is to be understood to mean the intensity of the relevant ultrasonic echo signal. The phase is to be understood to mean the oscillation state of the relevant ultrasonic echo signal at a particular location and at a particular time.

The flight time is to be understood to mean the time span between transmitting the relevant ultrasonic signal and receiving the associated ultrasonic echo signal.

According to one example embodiment of the present invention, it is provided that the processing unit is configured to determine the height of the object on the basis of a ratio of the amplitudes of the first ultrasonic echo signals and the second ultrasonic echo signals.

This is advantageous in that this is another simple way of determining the height of the object. In particular, the fact that the received ultrasonic echo signals have different amplitude values depending on whether they were excited by means of the first or the second frequency can be used here.

The ratio of the amplitudes of the ultrasonic echo signals depends in particular on the sound pressure, sound attenuation, and opening angle of the transmitted ultrasonic signals and in particular on the corresponding excitation frequency.

Furthermore, for example, corresponding amplitude ratios can be determined and stored in advance by in each case transmitting the first and second ultrasonic signals in a test environment for test objects of different heights and by assigning the received first and second ultrasonic echo signals to the corresponding object heights with respect to the amplitude ratios. In normal use, the system can then determine the object height by ascertaining the amplitude ratio between the first and second ultrasonic echo signals and comparing it to the stored amplitude ratios. For example, if the detected amplitude ratio is between two stored amplitude ratios that were detected in the test environment for test objects of a height of 40 cm and 50 cm, respectively, it can be concluded that the now-detected object has a height between 40 and 50 cm.

The present invention also relates to a vehicle, in particular a passenger car, comprising a system according to the present invention.

### BRIEF DESCRIPTION OF THE DRAWINGS

FIG. 1 shows in schematic form a vehicle designed according to the present invention using an example embodiment of the system according to the present invention.

FIG. 2 shows in detail an ultrasonic sensor unit controlled according to an example embodiment of the present invention.

### DETAILED DESCRIPTION OF EXAMPLE EMBODIMENTS

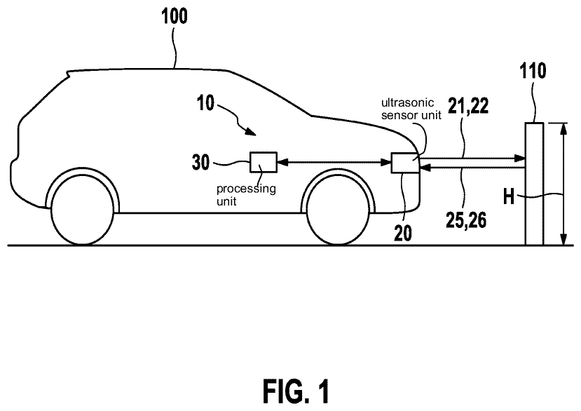

FIG. 1 shows in schematic form a vehicle designed according to the present invention using an embodiment of the system according to the present invention.

Shown is a schematic side view of a vehicle 100 designed according to the present invention, e.g., a passenger car, which is equipped with an embodiment of the system 10 according to the present invention.

The system 10 according to the present invention may, for example, comprise an ultrasonic sensor unit 20 designed as both an ultrasonic transceiver and an ultrasonic transceiver, and a processing unit 30 for controlling the operation of the ultrasonic sensor unit 20.

Via one or more detection lines and control lines, the processing unit 30 is connected to the ultrasonic sensor unit 20. In this way, the processing unit 30 can control the operation of the ultrasonic sensor unit 20 and/or query its status or receive or actively retrieve corresponding data or signals from the ultrasonic sensor unit 20.

The processing unit 30 is designed and comprises means which make possible both the operation of the transmission via the ultrasonic sensor unit 20 and the reception via the ultrasonic sensor unit 20 in the manner according to the present invention. For this purpose, corresponding means for storing, processing, and evaluating received first and second ultrasonic echo signals 25, 26 can be provided, which are not shown in detail here.

The processing unit 30 is here in particular configured to excite the ultrasonic sensor unit 20 with a first frequency to transmit first ultrasonic signals 21, and to detect the first ultrasonic signals 21 as first ultrasonic echo signals 25 when reflected on the object 110 and received by means of the ultrasonic sensor unit 20, and additionally to excite the ultrasonic sensor unit 20 with a second frequency to transmit second ultrasonic signals 22, and to detect the second ultrasonic signals 22 as second ultrasonic echo signals 26 when reflected on the object 110 and received by means of the ultrasonic sensor unit 20.

Furthermore, the processing unit 30 is configured to detect the object 110 in the surroundings of the vehicle 100 on the basis of the received first ultrasonic echo signals 25 and second ultrasonic echo signals 26 and, in addition, to determine a height H of the object 110 on the basis of the received first ultrasonic echo signals 25 and second ultrasonic echo signals 26. The object 110 may here, for example, be a post, which has a height H from the ground.

Here, the processing unit 30 can be configured to determine the height H of the object 110 on the basis of amplitudes and/or phases and/or flight times of the first ultrasonic echo signals 25 and second ultrasonic echo signals 26.

Alternatively or additionally, the processing unit 30 can be configured to determine the height H of the object 110 on the basis of a ratio of the amplitudes of the first ultrasonic echo signals 25 and second ultrasonic echo signals 26, for example by comparing the ascertained amplitude ratio to previously ascertained and stored amplitude ratios, which were detected for corresponding test objects of a specified height, and by determining a corresponding height H of the object 110 therefrom.

The ultrasonic sensor unit 20 can be operated in a first time period as an ultrasonic transmitter for transmitting the first and second ultrasonic signals 21, 22, whereas this ultrasonic sensor unit 20 is operated as an ultrasonic receiver in a subsequent second time period in order to receive the first and second ultrasonic echo signals 25, 26 as a direct echo. In an exemplary embodiment not shown in the drawings, a further ultrasonic sensor unit can function as an ultrasonic transmitter and thus transmit a first and second ultrasonic signal 21, 22 as a transmit signal. In this case, the ultrasonic sensor unit 20 can serve as an ultrasonic receiver for receiving the first and second ultrasonic echo signals 25, 26. Thus, in this configuration, a so-called cross echo is ascertained, in the case of which a first transceiver transmits the first and second ultrasonic signals 21, 22 and a second transceiver receives the first and second ultrasonic echo signals 25, 26. The combination of direct echo operation and cross echo operation can consequently be selected as desired, wherein at least two, correspondingly designed ultrasonic sensor units must be present in the case of cross echo operation.

In particular, the processing unit 30 can be configured to select the first frequency and the second frequency such that the first frequency corresponds to a main resonance frequency of the ultrasonic sensor unit 20 and that the second frequency corresponds to a frequency of a higher oscillation mode of the ultrasonic sensor unit 20, wherein the second frequency, for example, corresponds to a harmonic resonance frequency of the ultrasonic sensor unit 20, particularly preferably to the third harmonic.

Furthermore, the processing unit 30 can be configured to excite the ultrasonic sensor unit 20 with the first frequency and the second frequency substantially simultaneously.

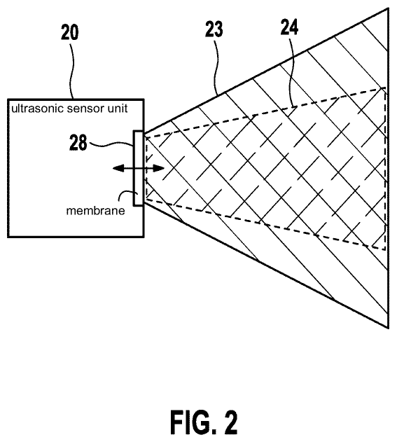

FIG. 2 shows in detail an ultrasonic sensor unit controlled according to the present invention.

Shown is an ultrasonic sensor unit 20, for example from the system according to FIG. 1, again in a side view. The ultrasonic sensor unit 20 comprises a membrane 28, which can be excited according to the present invention with a first frequency and a second frequency by a processing unit 30 (not shown here). As a result, the membrane 28 in each case oscillates back and forth in the direction of the arrow and generates the corresponding first ultrasonic signals 21 and second ultrasonic signals 22. If the first frequency corresponds to the main resonance frequency of the ultrasonic sensor unit 20 or of the membrane 28, a first radiation characteristic 23 results, which is shown as a solid hatched area. If the second frequency is a harmonic resonance frequency or a higher oscillation mode of the ultrasonic sensor unit 20 or of the membrane 28, and the second frequency is consequently higher than the first frequency, a second radiation characteristic 24 results, which is shown as a dashed-hatched area. It can be clearly seen that the opening angle of the first radiation characteristic 23 is larger than the opening angle of the second radiation characteristic 24. This in turn results in different information in the vertical direction from the two first and second ultrasonic echo signals 25, 26 received for the transmitted first and second ultrasonic signals 21, 22, which information can be used to accordingly determine the height of an object 100.

1-6. (canceled)

7. A system for detecting at least one object in surroundings of a vehicle, the system comprising:
at least one ultrasonic sensor unit configured to transmit ultrasonic signals and to receive reflected ultrasonic echo signals reflected on the at least one object in the surroundings of the vehicle; and
a processing unit configured to excite the ultrasonic sensor unit with a first frequency to transmit first ultrasonic signals, and to detect the first ultrasonic signals as first ultrasonic echo signals when reflected on the object and received by using the ultrasonic sensor unit, the processing unit additionally configured to excite the ultrasonic sensor unit with a second frequency to transmit second ultrasonic signals, and to detect the second ultrasonic signals as second ultrasonic echo signals when reflected on the object and received using the ultrasonic sensor unit, and, based on the received first ultrasonic echo signals and the received second ultrasonic echo signals, to detect the object in the surroundings of the vehicle and to determine a height of the object.

8. The system according to claim 7, wherein the processing unit is configured to select the first frequency and the second frequency such that the first frequency corresponds to a main resonance frequency of the ultrasonic sensor unit and that the second frequency corresponds to a frequency of a higher oscillation mode of the ultrasonic sensor unit, and the second frequency corresponds to a harmonic resonance frequency of the ultrasonic sensor unit.

9. The system according to claim 7, wherein the processing unit is configured to excite the ultrasonic sensor unit with the first frequency and the second frequency substantially simultaneously.

10. The system according to claim 7, wherein the processing unit is configured to determine the height of the object based on amplitudes and/or phases and/or flight times of the first ultrasonic echo signals and the second ultrasonic echo signals.

11. The system according to claim 7, wherein the processing unit is configured to determine the height of the object based on a ratio of the amplitudes of the first ultrasonic echo signals and the second ultrasonic echo signals.

12. A vehicle, comprising:
a system for detecting at least one object in surroundings of the vehicle, the system including:
at least one ultrasonic sensor unit configured to transmit ultrasonic signals and to receive reflected ultrasonic echo signals reflected on the at least one object in the surroundings of the vehicle, and
a processing unit configured to excite the ultrasonic sensor unit with a first frequency to transmit first ultrasonic signals, and to detect the first ultrasonic signals as first ultrasonic echo signals when reflected on the object and received by using the ultrasonic sensor unit, the processing unit additionally configured to excite the ultrasonic sensor unit with a second frequency to transmit second ultrasonic signals, and to detect the second ultrasonic signals as second ultrasonic echo signals when reflected on the object and received using the ultrasonic sensor unit, and, based on the received first ultrasonic echo signals and the received second ultrasonic echo signals, to detect the object in the surroundings of the vehicle and to determine a height of the object.
